(19) United States
(12) Patent Application Publication
(10) Pub. No.: US 2010/0143684 A1
(43) Pub. Date: Jun. 10, 2010

(54) FIBROUS VEIL IMPREGNATED WITH SURFACE FINISH FORMULATION

(75) Inventors: Paul A. Geel, Heveadorp (NL); Thomas S. Miller, Granville, OH (US); Dirk Kranendonk, Zutphen (NL)

Correspondence Address: OWENS CORNING, 2790 COLUMBUS ROAD, GRANVILLE, OH, 43023, US

(73) Assignees: OWENS CORNING, Toledo, OH (US); OWENS-CORNING VEIL NETHERLANDS B.V., Am Apeldoorn (NL)

(21) Appl. No.: 10/585,538

(22) PCT Filed: May 24, 2005
(86) PCT No.: PCT/US2005/018012

§ 371 Date: Mar. 4, 2009

Related U.S. Application Data
(60) Provisional application No. 60/581,008, filed on Jun. 18, 2004.

(51) Int. Cl. B32B 17/02; B32B 18/00; B32B 27/04

(52) U.S. Cl. 428/220; 442/180; 442/130; 442/76; 442/178; 442/173; 442/60; 427/372.2

(57) ABSTRACT

An impregnated fibrous veil comprises a nonwoven fibrous veil including a prebinder and reinforcing fibers. The fibers are selected from a group consisting of glass fibers, ceramic fibers and mixtures thereof. The nonwoven fibrous veil has at least one face impregnated with a surface finish formulation. The surface finish formulation includes about 50 to about 95 weight percent filler, about 5 to about 50 weight percent binder and about 0 to about 10 percent optical brightener.

### TECHNICAL FIELD AND INDUSTRIAL APPLICABILITY OF THE INVENTION

The present invention relates to an impregnated fibrous veil particularly characterized by a smooth surface finish and to a process for manufacturing that veil.

### BACKGROUND OF THE INVENTION

Fibrous webs or veils of intermingled, randomly oriented reinforcing fibers are well known in the art. Such veils have been used for a number of purposes.

For example, U.S. Pat. No. 6,497,787 to Geel discloses a process for making a microsphere-filled wet-laid veil useful as a lightweight core reinforcement for GRP sandwich panel applications. In this process a formed veil is passed on a belt through a first belt dryer wherein a prebinder is bonded to the nonwoven fibrous veil to form a prebonded nonwoven fibrous veil. An impregnation binder liquid including microspheres is then applied to the prebonded nonwoven fibrous veil and subsequently dried in a second dryer. The microspheres improve the rigidity or impact resistance of articles reinforced with the resulting microsphere-filled wet-laid veil.

In contrast, the present invention relates to an impregnated veil which may be incorporated into composite panels in order to provide products with improved surface smoothness and quality. Additional benefits derived from the use of the veil of the present invention in composite panels include reduced surface shrinkage, reduced warpage and better environmental durability.

### SUMMARY OF THE INVENTION

An impregnated fibrous veil is disclosed. The impregnated fibrous veil comprises a nonwoven fibrous veil including a prebinder and reinforcing fibers selected from a group consisting of glass fibers, ceramic fibers, and mixtures thereof. The nonwoven fibrous veil has at least one face impregnated with a surface finish formulation including about 50 to about 95 weight percent filler, about 5 to about 50 weight percent binder and about 0 to about 10 percent optical brightener.

Still more specifically describing the invention the impregnated fibrous veil may be further characterized by an air porosity of at least 1,500 l/m²s at 1 m Bar pressure. The impregnated fibrous veil is also characterized by a compressibility ratio of 1.2 or less between 0.5 and 25.0 kPa pressure. Further, the impregnated fibrous veil has a thickness of 0.5 mm or less at 0.5 kPa. Additionally, it should be appreciated that microspheres are substantially absent from the surface finish formulation.

The nonwoven fibrous veil includes about 5 to about 20 weight percent prebinder and between about 80 to about 95 weight percent reinforcing fibers. The prebinder used typically includes bonding fibers and typically thermoplastic bonding fibers. The prebinder may include bicomponent fibers. The prebinder is selected from a group of materials consisting of a water soluble binder, an emulsion binder, polymers and copolymers of styrene, butadiene, acrylic and methacrylic monomers, vinyl acetate, polyesters, polyvinyl alcohols, melamin formaldehyde resins, urea formaldehyde resins and mixtures thereof. The reinforcing fibers have a diameter between about 6.5 and about 16 microns and a length between about 4 and about 18 mm.

The filler utilized in the surface finish formulation is an inorganic filler that is dispersable in water. The inorganic filler has an average particle size in the range of between about 0.1 and 10.0 microns. The filler may be selected from a group consisting of calcium carbonate, aluminum trihydrate, titanium dioxide, magnesium hydroxide, silicium oxide, clay, talc and mixtures thereof.

The binder utilized in the surface finish formulation may include both thermosetting and thermoplastic resins. Typically the binder is a water dispersable emulsion type binder or a solution type binder. The binder may be selected from a group of materials consisting of polymers and copolymers of styrene, butadiene, acrylic, methacrylic monomers, vinyl acetate as well as polyesters, polyvinyl alcohols, melamin formaldehyde resins, urea formaldehyde resins and any mixtures thereof.

In accordance with yet another aspect of the present invention, a method of producing an impregnated fibrous veil with a smooth surface finish is provided. The method comprises impregnating at least one face of a nonwoven fibrous veil including a prebinder and reinforcing fibers with a surface finish formulation including about 50 to about 95 weight percent filler, about 5 to about 50 weight percent binder and about 0 to about 10 percent optical brightener.

The impregnating step includes applying the surface finish formulation to at least one face of the nonwoven fibrous veil at a rate of between about 15.0 to about 55.0 g/m² dry weight. The impregnating step further includes feeding the nonwoven fibrous veil in-line during the applying step. Still further the impregnating step includes drying and consolidating the impregnated fibrous veil following the applying step.

In the following description there is shown and described a preferred embodiment of this invention simply by way of illustration of one of the modes best suited to carry out the invention. As it will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain certain principles of the invention. In the drawings:

FIG. 1 is an edge on elevational view of the impregnated fibrous veil of the present invention; and

FIG. 2 is a schematical representation of the process for making that impregnated fibrous veil.

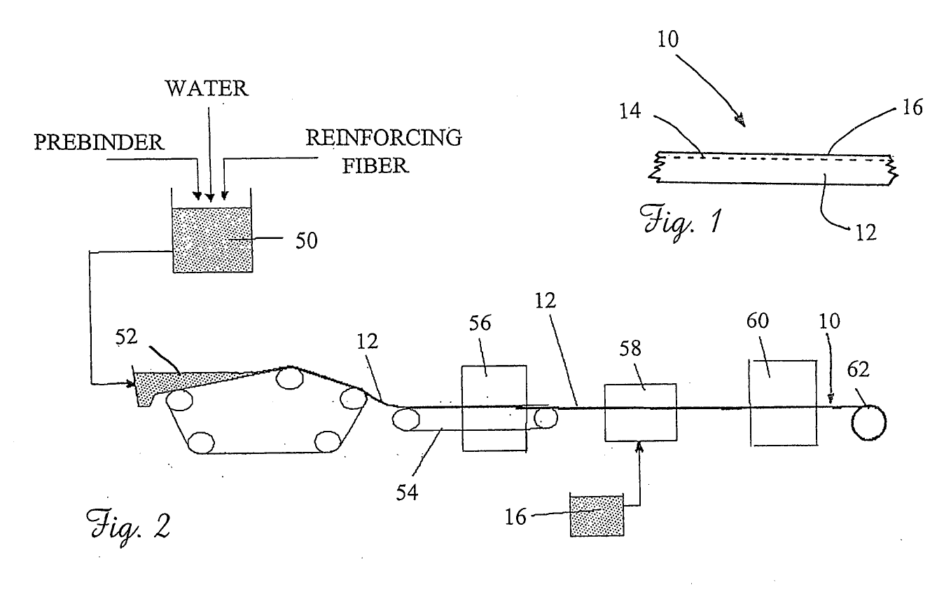

Reference will now be made in detail to the present preferred embodiment of the invention, an example of which is illustrated in the accompanying drawings.

### DETAILED DESCRIPTION AND PREFERRED EMBODIMENTS OF THE INVENTION

The present invention relates to an impregnated fibrous veil 10 including a wet-laid fibrous veil 12 of prebinder and reinforcing fibers having at least one face 14 thereof impregnated with a surface finish formulation 16. That surface finish formulation 16 includes about 50 to about 95 weight percent filler, about 5 to about 50 weight percent binder and about 0 to about 10 weight percent optical brightener.

As used herein, the term “wet-laid fibrous veil” refers to a web of intermingled, randomly oriented reinforcing fibers made according to a wet-laid process. The “veil” of the present invention may also include “sheets” or “mats” made in accordance with the wet-laid process. The fibers are preferably segmented and optionally, the formed veil may be reinforced with continuous filaments.

“Impregnating” or “impregnated” as used herein, refers to a means of integrating fillers into the fibrous veil. The method of impregnating may be conducted by any method suitable for integrating or incorporating these materials into the fibrous veil. In accordance with the present invention, the fillers are impregnated into the veil at any time after formation of the veil. In particular, the fillers are preferably impregnated after formation in a formation chamber, such as on a wire, or after being passed through a first dryer.

As previously noted, the impregnated fibrous veil 10 of the present invention comprises a nonwoven wet-laid fibrous veil 12 including a prebinder and reinforcing fibers selected from a group consisting of glass fibers, ceramic fibers and mixtures thereof. More specifically, the nonwoven fibrous veil 12 includes about 5 to about 20 weight percent prebinder and between about 80 to about 95 weight percent reinforcing fibers. The prebinder includes bonding fibers and preferably thermoplastic bonding fibers. The prebinder may also include bicomponent fibers. The prebinder may be selected from a group of materials consisting of water soluble binders or emulsion type binders, such as polymers and copolymers of styrene, butadiene, acrylic and methacrylic monomers, vinyl acetate as well as polyesters, polyvinyl alcohols, melamin formaldehyde resins, urea formaldehyde resins and mixtures thereof. The reinforcing fibers typically have a diameter between about 6.5 and about 16 microns and a length between about 4 and about 18 mm.

At least one face 14 of the nonwoven fibrous veil 12 is impregnated with a surface finish formulation 16. That surface finish formulation includes about 50 to about 95 weight percent filler, about 5 to about 50 weight percent binder and about 0 to about 10 percent optical brightener. Typically the filler is an inorganic filler that is dispersable in water. Preferably all filler particles are less than 50 microns in size in order to insure good surface quality or smoothness. A typical average particle size range is from about 0.1 to about 10.0 microns. For certain applications an average particle size of 5 microns is preferred. Fillers useful in the present invention include but are not limited to calcium carbonate, aluminum trihydrate, titanium dioxide, magnesium hydroxide, silicium oxide, clay, talc and mixtures thereof.

The binder of the surface finish formulation may include both thermosetting and thermoplastic resins. Typically the binder is a water dispersable emulsion type binder. Alternatively, it may be a solution type binder. Binders useful in the surface finish formulation 16 include but are not limited to polymers and copolymers of styrene, butadiene, acrylic and methacrylic monomers, vinyl acetate as well as polyesters, polyvinyl alcohols, melamin formaldehyde resins, urea formaldehyde reins and any mixtures thereof.

The optional optical brightener useful in the surface finish formulation 16 is preferably a water dispersable optical brightener that is not sensitive to degradation due to weathering. Thus, the optical brightener must, for example, be resistant to ultraviolet radiation of the sun. Further, when the impregnated fibrous veil 10 is used, for example, as part of a composite panel on a motor vehicle, the optical brightener must be resistant to corrosive environmental agents common to roadways including but not limited to salt and petroleum products. An example of an appropriate optical brightener useful in the surface finish formulation 16 is Leucophor UO as manufactured and sold by Clariant Benelux.

The process of manufacturing the impregnated fibrous veil 10 of the present invention is illustrated in FIG. 2. In the illustrated wet lay process, the prebinder, reinforcing fibers and water are agitated in a mixing tank 50 to provide an aqueous fiber slurry. The reinforcing fibers may be used as filaments or as strands of gathered filaments in chopped form. Optionally, continuous filaments can be used as length-oriented reinforcement for the veil. Additional elements to make up the aqueous slurry may be added as is known in the art. For example, antistatic agents, coupling agents, pigments, surfactants, anti-foams, colorants and fillers may be provided along with the prebinder into the slurry.

As illustrated in FIG. 2 the aqueous fiber slurry is transferred from the mixing tank 50 onto a suitable forming apparatus 52. The forming apparatus may, for example, take the form of a moving screen or forming wire on an inclined wire forming machine, wire cylinders, Foudrinier machines, Stevens Former, Roto Former, Inver Former or Venti Former machines. Preferably, the formation of the veil 12 is on an inclined wire forming machine. The fibers and the additional slurry elements in the aqueous fiber slurry enmesh themselves into a freshly prepared wet laid fibrous veil 12 on the forming apparatus 52 while excess water is separated therefrom. The dewatering step may be conducted by any known method such as by draining, vacuum, etc. The water content of the veil after dewatering and vacuum is preferably in the range of about 50 to about 85%.

After the wet-laid nonwoven fibrous veil 12 is formed, the veil is transferred to a transport belt 54. The belt 54 carries the veil 12 into a means 56 for substantially removing the water. The removal of water may be conducted by known web drying methods, including the use of a rotary/through air dryer or oven, a heated drum dryer, an infrared heating source, hot air blowers, microwave emitting source and the like. At least one method of drying is necessary for removing the water but a plurality of these methods may be used in combination to remove the water and dry the wet laid fibrous veil 12. The temperature of the dryer may range from about 120 degrees C. at the start until about 210 degrees C. at the end of the first drying process. The air speed may be in the range of about 0.5 to 1 m/s. During drying the prebinder is bound to the reinforcing fibers in order to prebond the veil 12.

A face 14 of the prebonded veil 12 is then impregnated with the surface finish formulation 16. Any method suitable for impregnating the face 14 of the prebonded veil 12 may be used. For example, suitable methods include using a size press 58, such as a Foulard applicator, a binder wire, rotary screen, dipping roll, spraying, coating equipment and the like. While other additional agents or coatings may be applied, preferably only the surface finish formulation 16 is contacted with the prebonded veil 12. Following the impregnation of the face 14 of the prebonded veil 12 with the surface finish formulation 16, is the drying and consolidating of the impregnated fibrous veil 10. Thus the now impregnated veil 10 is dried in a second dryer 60 which is preferably an airfloat oven. The resulting dried impregnated fibrous veil 10 is then collected on a winder 62.

The veil 10 of the present invention may be used in composite panels that may be subsequently molded into any desired shape. Such panels are particularly useful as body panels in the truck and automotive fields. Advantageously, such panels incorporating the impregnated fibrous veil 10 of the present invention exhibit a number of beneficial properties including reduced surface shrinkage, reduced warpage and improved surface smoothness. Additionally, the panels provide better environmental durability.

The following examples are presented in order to further illustrate the invention, but is not to be considered as limited thereto.

### EXAMPLE 1

A 35 grams per square meter (gsm) veil consisting of 87% 11 micron 6 mm glass and 13% polyvinyl alcohol prebinder is formed using a wet laid process using an inclined wire former. This veil is fed to a belt dryer and dried and cured to form a prebonded sheet. The sheet is subsequently in-line impregnated using a size press Foulard applicator with a binder/filler mixture consisting of 10% styrene acrylic emulsion commercially available from BASF as “Acronal LR8988” and 90% calcium carbonate, commercially available from OMYA as “Durcal 5”. The binder/filler mixture is controlled with a vacuum system and the target dry add-on set at 35 gsm. The impregnated sheet is fed to an airfloat oven to dry the sheet and consolidate the filler. Depending upon the speed, the temperature used is between about 120 degrees C. and 180 degrees C. With these settings, an end product thickness from about 0.40 mm and a stiffness (Gurley) from about 450 mg can be reached while the air porosity level is kept at 2600 l/m²s.

### EXAMPLE 2

A 35 gsm veil consisting of 87% 11 micron 6 mm glass and 13% polyvinyl alcohol to prebinder is formed using a wet-laid process using a Foudrinier former with inclined wire. This veil is fed to a belt dryer and dried and cured to form a prebonded sheet. The sheet is subsequently in-line impregnated using a size press Foulard applicator with a binder/filler mixture consisting of 10% polyvinyl alcohol (Kuraray, Mowiol 28-99) and 90% calcium carbonate (OMYA, Durcal 5). The binder/filler mixture is controlled with a vacuum system and the target dry add-on set at 35 gsm. The impregnated sheet is fed to an airfloat oven to dry the sheet and consolidate. Depending upon the speed, which is usually about 100 meters/minute, the temperatures used are between about 120 degrees C. and 180 degrees C. With these settings, an end product thickness from about 0.40 mm and a Gurley stiffness from about 600 mg can be reached with the air porosity level at 1900 l/m²s.

### EXAMPLE 3

A 35 grams per square meter (gsm) veil consisting of 87% 11 micron 6 mm glass and 13% PVA prebinder is formed using a wet-laid process using an inclined wire former. This veil is fed to a belt dryer and dried and cured to form a prebonded sheet. The sheet is subsequently in-line impregnated using a size press Foulard applicator with a binder/filler mixture consisting of 10% styrene acrylic resin commercially available from BASF as “Acronal LR8988” and 90% calcium carbonate, commercially available from OMYA as “Durcal 5”. The binder/filler mixture is controlled with a vacuum system and the target dry add-on set at 25 gsm. The impregnated sheet is fed to an airfloat oven to dry the sheet and consolidate the filler. Depending upon the speed, the temperature used is between about 120 degrees C. and 180 degrees C. With these settings, an end product thickness from about 0.40 mm and a stiffness (Gurley) from about 320 mg can be reached while the air porosity level is kept at 2800 l/m²s.

The impregnated fibrous veil 10 of the present invention is characterized by a unique combination of properties. The veil 10 has an air porosity of at least 1,500 l/m²s at 1 m Bar pressure. This allows a very fast and good wet out of the surface veil with resin. Further, the veil 10 has a thickness of 0.5 mm or less at 0.5 kPa. The veil 10 is thin but retains good print through hiding power. Further, the veil 10 has a compressibility ratio of 1.2 or less between 0.5 and 25.0 kPa pressure. This characteristic also enhances the print through hiding capacity of the veil 10.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, in accordance with the method illustrated in FIG. 2, the prebinder and reinforcing fibers are heat cured prior to application of the surface finish formulation. It should be appreciated, however, that the surface finish formulation may be applied to the nonwoven fibrous veil including the prebinder and reinforcing fibers prior to curing of the prebinder. In this way both the prebinder and surface finish, formulation are cured simultaneously during a single heating step.

In addition, while it is preferred that the surface finish formulation is applied inline to the prebonded fibrous veil, it does not have to be. Further, while the process as illustrated in FIG. 2 relates to the application of the surface finish formulation to only one face 14 of the veil 12, it should be appreciated that it may be applied to both, opposing faces. Thus, the veil 12 may be brought into the Foulard applicator to assure that the prebonded veil 12 is wetted on both sides. This may be done by bringing the veil into the applicator from above in a double roll system, wherein surface finish formulation is capable of coating both sides/faces of the veil. Subsequently, the impregnated veil 10 is dried and/or cured in an oven or other drying device.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. An impregnated fibrous veil, comprising:
a nonwoven fibrous veil including a prebinder and reinforcing fibers selected from a group consisting of glass fibers, ceramic fibers, and mixtures thereof, said nonwoven fibrous veil having at least one face impregnated with a surface finish formulation including about 50 to about 95 weight percent filler, about 5 to about 50 weight percent binder and about 0 to about 10 percent optical brightener.

2. The impregnated fibrous veil of claim 1, further characterized by an air porosity of at least 1,500 l/m²s at 1 m Bar pressure.

3. The impregnated fibrous veil of claim 2, wherein microspheres are substantially absent from said surface finish formulation.

4. The impregnated fibrous veil of claim 1, wherein said impregnated fibrous veil is further characterized by a compressibility ratio of 1.2 or less between 0.5 and 25.0 kPa pressure.

5. The impregnated fibrous veil of claim 2, wherein said impregnated fibrous veil has a thickness of 0.5 mm or less at 0.5 kPa.

6. The impregnated fibrous veil of claim 3 wherein said nonwoven fibrous veil includes about 5 to about 20 weight percent prebinder and between about 80 to about 95 weight percent reinforcing fibers.

7. The impregnated fibrous veil of claim 4, wherein said prebinder includes bonding fibers.

8. The impregnated fibrous veil of claim 4, wherein said prebinder includes thermoplastic bonding fibers.

9. The impregnated fibrous veil of claim 4, wherein said prebinder includes bicomponent fibers.

10. The impregnated fibrous veil of claim 4 wherein said prebinder is selected from a group of materials consisting of a water soluble binder, an emulsion binder, polymers and copolymers of styrene, butadiene, acrylic and methacrylic monomers, vinyl acetate, polyesters, polyvinyl alcohols, melamin formaldehyde resins, urea formaldehyde resins and mixtures thereof.

11. The impregnated fibrous veil of claim 5 wherein said reinforcing fibers have a diameter between about 6.5 and about 16.0 microns and a length between about 4 and about 18 mm.

12. The impregnated fibrous veil of claim 11, wherein said filler is an inorganic filler that is dispersable in water.

13. The impregnated fibrous veil of claim 12, wherein said inorganic filler has an average particle size in the range of about 0.1 to about 10.0 microns.

14. The impregnated fibrous veil of claim 13, wherein said filler is selected from a group consisting of calcium carbonate, aluminum trihydrate, titanium dioxide, magnesium hydroxide, silicium oxide, clay, talc and mixtures thereof.

15. The impregnated fibrous veil of claim 14, wherein said binder includes both thermosetting and thermoplastic resins.

16. The impregnated fibrous veil of claim 14, wherein said binder is a water dispersable emulsion type binder or a solution type binder.

17. The impregnated fibrous veil of claim 14, wherein said binder is selected from a group of materials consisting of a water soluble binder, an emulsion binder, polymers and copolymers of styrene, butadiene, acrylic and methacrylic monomers, vinyl acetate, polyesters, polyvinyl alcohols, melamin formaldehyde resins, urea formaldehyde resins and mixtures thereof.

18. A method of producing an impregnated fibrous veil with a smooth surface finish, comprising:
impregnating at least one face of a nonwoven fibrous veil including a prebinder and reinforcing fibers with a surface finish formulation including about 50 to about 95 weight percent filler, about 5 to about 50 weight percent binder and about 0 to about 10 weight percent optical brightener.

19. The method of claim 18 wherein said impregnating step includes applying said surface finish formulation to said at least one face of said nonwoven fibrous veil at a rate of between about 15.0 and 55.0 g/m².

20. The method of claim 19, wherein said impregnating step includes feeding said nonwoven fibrous veil in-line during said applying step.

21. The method of claim 20, wherein said impregnating step includes drying and consolidating said impregnated fibrous veil following said applying step.

22. The method of claim 18 further including producing a nonwoven fibrous veil and performing said impregnating step inline with said nonwoven fibrous veil production.
